(19) United States
(12) Patent Application Publication
(10) Pub. No.: US 2026/0045017 A1
(43) Pub. Date: Feb. 12, 2026

(54) MEDICAL IMAGING SYSTEM AND IMAGE RECONSTRUCTION METHOD THEREFOR

(71) Applicant: GE Precision Healthcare LLC, Waukesha, WI (US)

(72) Inventors: Xueli Wang, Beijing (CN); Dan Liu, Beijing (CN)

(21) Appl. No.: 19/296,590

(22) Filed: Aug. 11, 2025

(30) Foreign Application Priority Data
Aug. 12, 2024 (CN) 202411101070.6

(51) Int. Cl. G06T 11/00; G06T 5/60

(52) U.S. Cl. CPC G06T 11/003; G06T 5/60; G06T 2207/10081; G06T 2207/20081

(57) ABSTRACT

An imaging system and reconstruction method are described. The method includes identifying at least one region of interest in a first reconstructed image, generating a region-of-interest orthographic projection image of each region of interest and a background-region orthographic projection image of a background region, obtaining a region-of-interest filtered orthographic projection image of each region of interest and a background-region filtered orthographic projection image, wherein the region-of-interest filtered orthographic projection image is obtained by filtering a current-region-of-interest orthographic projection image using a filter kernel function matched with a current region of interest, and the background-region filtered orthographic projection image is obtained by filtering the background-region orthographic projection image using a filter kernel function matched with the background region, and generating a second reconstructed image based on the region-of-interest filtered orthographic projection image of each region of interest and the background-region filtered orthographic projection image.

### CROSS-REFERENCES TO RELATED APPLICATIONS

This application claims priority to Chinese Application No. 202411101070.6, filed on Aug. 12, 2024, the disclosure of which is incorporated herein by reference in its entirety.

### TECHNICAL FIELD

The present disclosure relates to the field of imaging, and specifically, to an imaging system and an image reconstruction method therefor.

### BACKGROUND

Imaging techniques allow for non-invasive acquisition of images of internal structures or features of a subject under examination (such as a patient). A digital X-ray imaging system produces digital data that may be reconstructed into radiographic images, such as in a computed tomography (CT) or digital breast tomosynthesis (DBT) imaging process. In the digital X-ray imaging system, radiation from a source is directed toward the subject under examination. A portion of the radiation passes through the subject under examination and impacts a detector. The detector includes an array of discrete picture elements or detector pixels and generates an output signal based on the amount or intensity of radiation that impacts each pixel region. The output signal, a view, or a projection is then processed to generate images that may be displayed for viewing. These images are used to identify and/or examine the internal structures and organs within a patient's body.

The digital X-ray imaging system obtains a plurality of projections of the subject under examination, referred to as orthographic projection images, and then reconstructs these views, such as through a filtered back projection (FBP) process, to create a volume from projection data. During image reconstruction, a filter kernel function (kernel, or referred to as a filter function kernel, a reconstruction function kernel, a reconstruction filter, or a filter convolution kernel) is used to process the projection data.

### SUMMARY OF THE INVENTION

In the present disclosure, it is realized that different tissues/organs correspond to different filter function kernels, and different filter function kernels have different cut-off frequencies. An existing imaging system uses a same filter function kernel in a certain tomographic section or a plurality of tomographic interfaces. Correspondingly, in a reconstructed image, some tissue/organ region images may have higher imaging quality, while images of other regions may have lower imaging quality, for example, have more severe artifacts.

An objective of the present disclosure is intended to overcome the above-mentioned and/or other problems in the prior art. According to the present disclosure, a medical imaging system and an image reconstruction method therefor are provided, which may select suitable filter kernels with corresponding cut-off frequencies for one or a plurality of regions of interest, so that crosstalk between different tissues/organs is reduced and image quality is improved. In addition, a more simplified processing process can be provided, processing efficiency can be improved, and a requirement on disk space can be lowered.

According to a first aspect of the present disclosure, an image reconstruction method for a medical imaging system is provided, including identifying at least one region of interest in a first reconstructed image of an examination subject; generating a region-of-interest orthographic projection image of each region of interest among the at least one region of interest and a background-region orthographic projection image of a background region other than the at least one region of interest; obtaining a region-of-interest filtered orthographic projection image of each region of interest and a background-region filtered orthographic projection image, wherein for each region of interest among the at least one region of interest, the region-of-interest filtered orthographic projection image is obtained by filtering a current-region-of-interest orthographic projection image using a filter kernel function relatively matched with a current region of interest, and the background-region filtered orthographic projection image is obtained by filtering the background-region orthographic projection image using a filter kernel function relatively matched with the background region; and generating a second reconstructed image based on the region-of-interest filtered orthographic projection image of each region of interest and the background-region filtered orthographic projection image.

In an embodiment, the generating the background-region orthographic projection image comprises performing an orthographic projection for the first reconstructed image from which the at least one region of interest is removed to obtain the background-region orthographic projection image; and the generating the region-of-interest orthographic projection image of each region of interest comprises: for each region of interest, generating an other-region orthographic projection image of regions other than the current region of interest in the first reconstructed image; and subtracting the other-region orthographic projection image from an orthographic projection image corresponding to the first reconstructed image to generate a region-of-interest orthographic projection image of the current region of interest.

In an embodiment, the generating the background-region orthographic projection image comprises performing an orthographic projection for the first reconstructed image from which the at least one region of interest is removed to obtain the background-region orthographic projection image; and the generating the region-of-interest orthographic projection image of each region of interest comprises: for each region of interest, performing an orthographic projection only for the current region of interest in the first reconstructed image to generate a region-of-interest orthographic projection image of the current region of interest.

In an embodiment, the generating the second reconstructed image based on the region-of-interest filtered orthographic projection image of each region of interest and the background-region filtered orthographic projection image comprises: combining the region-of-interest filtered orthographic projection image of each region of interest and the background-region filtered orthographic projection image into an overall filtered orthographic projection image; and performing back projection for the overall filtered orthographic projection image to obtain the second reconstructed image.

In an embodiment, the generating the second reconstructed image based on the region-of-interest filtered orthographic projection image of each region of interest and the background-region filtered orthographic projection image comprises: performing back projection for each region-of-interest filtered orthographic projection image and the background-region filtered orthographic projection image respectively to obtain a local reconstructed image of each region of interest and a background-region reconstructed image of the background region; and replacing an image covering a corresponding position in the background-region reconstructed image with the local reconstructed image of each region of interest to obtain the second reconstructed image.

In an embodiment, the generating the second reconstructed image further comprises: scaling the local reconstructed image of each region of interest to obtain a same range as the image at the corresponding position in the background-region reconstructed image, and replacing the image at the corresponding position in the background-region reconstructed image with the scaled local reconstructed image.

In an embodiment, the generating the second reconstructed image further comprises: further cropping the scaled local reconstructed image of each region of interest based on a range of the corresponding position in the background-region reconstructed image to remove a portion of the scaled local reconstructed image outside the range of the corresponding position.

In an embodiment, the filter kernel functions relatively matched with the region of interest and the background region respectively are determined based on an optimal filtering frequency of a corresponding region.

In an embodiment, the first reconstructed image is obtained by performing reconstruction on the examination subject at a maximum field of view of the medical imaging system.

In an embodiment, each region of interest among the at least one region of interest is labeled with an anatomical structure of the examination subject and is automatically labeled through deep learning.

According to a second aspect of the present disclosure, a medical imaging system is provided, comprising: a scanning device, configured to acquire a first reconstructed image of an examination subject; and a processor, configured to: identify at least one region of interest in the first reconstructed image of the examination subject; generate a region-of-interest orthographic projection image of each region of interest among the at least one region of interest and a background-region orthographic projection image of a background region other than the at least one region of interest; obtain a region-of-interest filtered orthographic projection image of each region of interest and a background-region filtered orthographic projection image, wherein for each region of interest among the at least one region of interest, the region-of-interest filtered orthographic projection image is obtained by filtering a current-region-of-interest orthographic projection image using a filter kernel function relatively matched with a current region of interest, and the background-region filtered orthographic projection image is obtained by filtering the background-region orthographic projection image using a filter kernel function relatively matched with the background region; and generate a second reconstructed image based on the region-of-interest filtered orthographic projection image of each region of interest and the background-region filtered orthographic projection image.

In an embodiment, the processor is configured to: generate the background-region orthographic projection image by performing an orthographic projection for the first reconstructed image from which the at least one region of interest is removed; and generate the region-of-interest orthographic projection image of each region of interest by the following: for each region of interest, generating an other-region orthographic projection image of regions other than the current region of interest in the first reconstructed image; and subtracting the other-region orthographic projection image from an orthographic projection image corresponding to the first reconstructed image to generate a region-of-interest orthographic projection image of the current region of interest.

In an embodiment, the processor is configured to: generate the background-region orthographic projection image by performing an orthographic projection for the first reconstructed image from which the at least one region of interest is removed; and generate the region-of-interest orthographic projection image of each region of interest by the following: for each region of interest, performing an orthographic projection only for the current region of interest in the first reconstructed image to generate a region-of-interest orthographic projection image of the current region of interest.

In an embodiment, the processor is configured to generate the second reconstructed image based on the region-of-interest filtered orthographic projection image of each region of interest and the background-region filtered orthographic projection image by the following: combining the region-of-interest filtered orthographic projection image of each region of interest and the background-region filtered orthographic projection image into an overall filtered orthographic projection image; and performing back projection for the overall filtered orthographic projection image to obtain the second reconstructed image.

In an embodiment, the processor is configured to generate the second reconstructed image based on the region-of-interest filtered orthographic projection image of each region of interest and the background-region filtered orthographic projection image by the following: performing back projection for each region-of-interest filtered orthographic projection image and the background-region filtered orthographic projection image respectively to obtain a local reconstructed image of each region of interest and a background-region reconstructed image of the background region; and replacing an image at a corresponding position in the background-region reconstructed image with the local reconstructed image of each region of interest to obtain the second reconstructed image.

In an embodiment, the processor is further configured to generate the second reconstructed image by the following: scaling the local reconstructed image of each region of interest to obtain a same range as the image at the corresponding position in the background-region reconstructed image, and replacing the image at the corresponding position in the background-region reconstructed image with the scaled local reconstructed image.

In an embodiment, the processor is further configured to generate the second reconstructed image by the following: further cropping the scaled local reconstructed image of each region of interest based on a range of the corresponding position in the background-region reconstructed image to remove a portion of the scaled local reconstructed image outside the range of the corresponding position.

In an embodiment, the filter kernel functions relatively matched with the region of interest and the background region respectively are determined based on an optimal filtering frequency of a corresponding region.

In an embodiment, the first reconstructed image is obtained by performing reconstruction on the subject at a maximum field of view of the medical imaging system.

In an embodiment, each region of interest among the at least one region of interest is labeled with an anatomical structure of the subject and is automatically labeled through deep learning.

According to a third aspect of the present disclosure, a non-transient computer-readable medium is provided, having instructions stored thereon. The instructions are executable by a processor to implement the method according to any one of the aforementioned embodiments.

According to a fourth aspect of the present disclosure, a computer program product is provided, comprising instructions. The instructions are executable by a processor to implement the method according to any one of the aforementioned embodiments.

### BRIEF DESCRIPTION OF THE DRAWINGS

The present invention can be better understood by means of the description of the exemplary embodiments of the present invention in conjunction with the drawings, in which:

FIG. 1 is a schematic diagram of an exemplary CT system 100 configured for CT imaging;

FIG. 2 shows an exemplary imaging system similar to the CT system in FIG. 1;

FIG. 3 is a schematic diagram of a CT system during patient detection;

FIG. 4 is a flowchart of an image reconstruction method;

FIG. 5a to FIG. 5c show reconstructed images obtained according to an image reconstruction method;

FIG. 6 is a flowchart of an image reconstruction method for a medical imaging system according to one embodiment of the present disclosure;

FIG. 7 is a flowchart of a method for generating a second reconstructed image according to one embodiment of the present disclosure;

FIG. 8 is a flowchart of a method for generating a second reconstructed image according to another embodiment of the present disclosure; and

FIG. 9 is an example block diagram of a computing device according to a technique of the present disclosure.

In the accompanying drawings, similar components and/or features may have the same numerical reference signs. Further, components of the same type may be distinguished by letters following the reference sign, and the letters may be used for distinguishing between similar components and/or features. If only a first numerical reference sign is used in the specification, the description is applicable to any similar component and/or feature having the same first numerical reference sign irrespective of the subscript of the letter.

### DETAILED DESCRIPTION

Specific implementations of the present invention will be described below. It should be noted that in the specific description of said implementations, for the sake of brevity and conciseness, the present description cannot describe all of the features of the actual implementations in detail. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for those of ordinary skill in the art related to the content disclosed in the present invention, some design, manufacture, or production changes made on the basis of the technical content disclosed in the present disclosure are only common technical means, and should not be construed as the content of the present disclosure being insufficient.

References in the specification to “an embodiment”, “embodiment”, “example embodiment”, and so on indicate that the embodiment described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless defined otherwise, technical terms or scientific terms used in the claims and description should have the usual meanings that are understood by those of ordinary skill in the technical field to which the present invention belongs. The terms “include” or “comprise” and similar words indicate that an element or object preceding the terms “include” or “comprise” encompasses elements or objects and equivalent elements thereof listed after the terms “include” or “comprise”, and do not exclude other elements or objects.

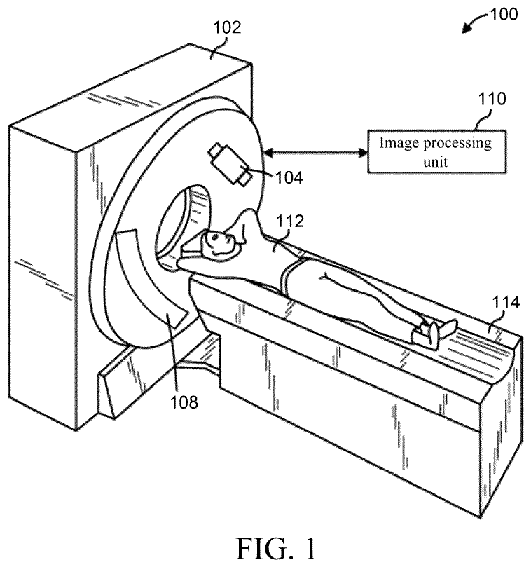

Implementations of the present disclosure are described below by way of example with reference to FIG. 1 to FIG. 9. The following description relates to various examples of an imaging method and an imaging system. Specifically, the imaging method and an imaging device are provided.

Although a CT system is described by way of example, it should be understood that the techniques of the present disclosure are broadly applicable to various fields of non-destructive examination. The techniques of the present disclosure may also be useful when applied to images acquired by using other imaging modalities, such as an X-ray imaging system, a magnetic resonance imaging (MRI) system, a positron emission tomography (PET) imaging system, a single photon emission computed tomography (SPECT) imaging system, and combinations thereof (e.g., a multi-modal imaging system such as a PET/CT, PET/MR, or SPECT/CT imaging system). As an example, the embodiments of the present application are described below in conjunction with an X-ray computed tomography (CT) imaging. Those skilled in the art would appreciate that the embodiments of the present application can also be applied to other medical imaging.

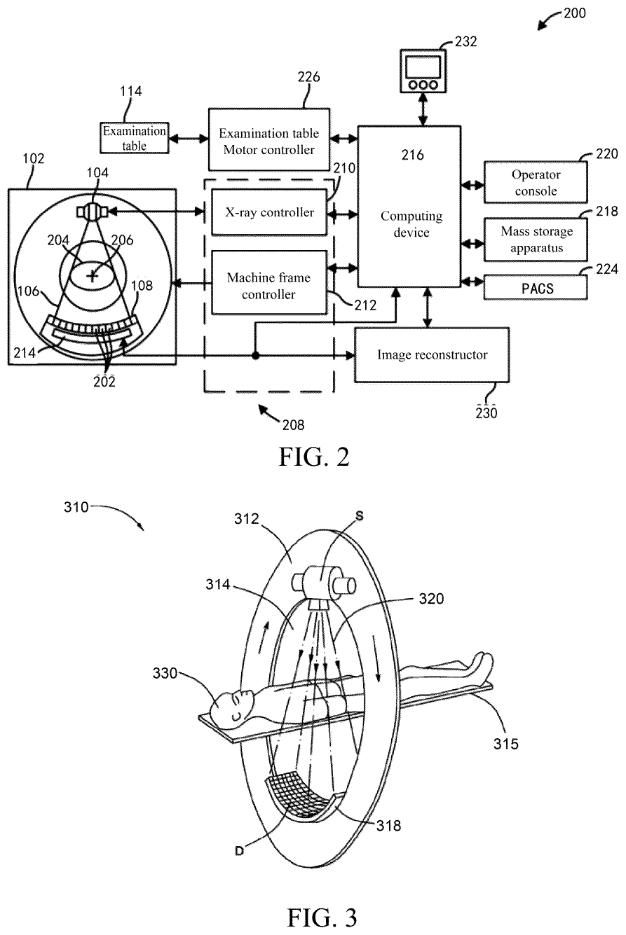

FIG. 1 is a schematic diagram of an exemplary CT system 100 configured for CT imaging. Specifically, the CT system 100 is configured to image a subject under examination 112 (such as a patient, an inanimate object, or one or a plurality of manufactured components or industrial components) and/or a foreign object (such as a dental implant, a stent, and/or a contrast agent present in the body). In one implementation, the CT system 100 includes a machine frame 102, which in turn may further include at least one X-ray source 104. The at least one X-ray source is configured to project an X-ray radiation beam 106 (see FIG. 2) for imaging the subject under examination 112 lying on an examination table 114. Specifically, the X-ray source 104 is configured to project the X-ray radiation beam 106 toward a detector array 108 positioned on the opposite side of the machine frame 102. Although FIG. 1 a single X-ray source 104, in certain implementations, a plurality of X-ray sources and detectors may be used to project a plurality of X-ray radiation beams, so as to acquire projection data corresponding to the patient at different energy levels. In some implementations, the X-ray source 104 may achieve dual-energy gemstone spectral imaging (GSI) by means of rapid peak kilovoltage (kVp) switching. In some implementations, the X-ray detectors which are used are photon counting detector capable of distinguishing X-ray photons of different energies. In other implementations, dual-energy projections are generated using two sets of X-ray sources and detectors, wherein one set of X-ray sources and detectors is set to low kVp and the other set is set to high kVp. It should therefore be understood that the methods described herein may be implemented using single-energy acquisition techniques and dual-energy acquisition techniques.

In certain implementations, the CT system 100 further includes an image processor unit 110, which is configured to reconstruct an image of a target volume of the subject under examination 112 by using an iterative or analytical image reconstruction method. For example, the image processor unit 110 may reconstruct an image of a target volume of the patient by using an analytical image reconstruction method such as filtered back projection (FBP). As another example, the image processor unit 110 may reconstruct, by using an iterative image reconstruction method (such as advanced statistical iterative reconstruction (ASIR), conjugate gradient (CG), maximum likelihood expectation maximization (MLEM), model-based iterative reconstruction (MBIR), etc), an image of a target volume of the subject under examination 112. As further described herein, in some examples, in addition to the iterative image reconstruction method, the image processor unit 110 may use an analytical image reconstruction method (such as FBP).

In some CT imaging system configurations, the X-ray source projects a conical X-ray radiation beam, which is collimated to be located within an X-Y-Z plane of a Cartesian coordinate system, and the plane is usually referred to as an “imaging plane”. The X-ray radiation beam passes through a subject being imaged, such as a patient or a subject under examination. The X-ray radiation beam is irradiated on a detector element array after being attenuated by the subject. The intensity of the attenuated X-ray radiation beam received at the detector array depends on the attenuation of the X-ray radiation beam by the subject. Each detector element of the array produces a separate electrical signal that is a measure of the X-ray beam attenuation at the detector position. Attenuation measurements from all detector elements are individually acquired to generate a transmission profile.

In some CT systems, the machine frame is used to rotate the X-ray source and the detector array in the imaging plane around the subject to be imaged so that the angle at which the X-ray beam intersects the subject is constantly changing. A set of X-ray radiation attenuation measurement results (e.g., projection data) from the detector array at one machine frame angle is referred to as a “view”. A “scan” of the subject includes a set of views made at different machine frame angles or viewing angles during one rotation of the X-ray source and detector. It is conceivable that the benefits of the method described herein may arise from a medical imaging modality other than CT. Therefore, as used herein, the term “view” is not limited to the use described above with respect to projection data from one machine frame angle. The term “view” is used to mean one data acquisition when there are a plurality of data acquisitions from different angles (whether from CT, positron emission tomography (PET), or single photon emission CT (SPECT) acquisitions), and/or any other modalities (including modalities yet to be developed) and combinations thereof in fused implementations.

Projection data is processed to reconstruct images corresponding to two-dimensional slices acquired by means of the subject, or in some examples in which the projection data includes a plurality of views or scans, reconstruct the images corresponding to three-dimensional image of the subject. A method for reconstructing an image from a set of projection data is referred to as a filtered back projection technique in the art. Transmission and emission tomography reconstruction techniques also include statistical iterative methods, such as maximum likelihood expectation maximization (MLEM) and ordered subset expectation reconstruction techniques, as well as iterative reconstruction techniques. The method converts an attenuation measurement from a scan into an integer referred to as a “CT number” or “Hounsfield unit”, which is used to control the brightness of a corresponding pixel on a display device.

To reduce the total scan time, a “helical” scan may be performed. To perform the “helical” scan, the patient is moved when data of a specified number of slices is acquired. Such systems produce a single helix from helical scanning of a conical beam. The helix mapped out by the conical beam produces projection data according to which an image in each specified slice can be reconstructed.

As used herein, the phrase “reconstructed image” is not intended to exclude an implementation in which data representing an image is generated without generating a viewable image. Therefore, as used herein, the term “image” broadly refers to both a viewable image and data representing a viewable image. However, many embodiments generate (or are configured to generate) at least one viewable image.

FIG. 2 shows an exemplary imaging system 200 similar to the CT system 100 in FIG. 1. According to aspects of the present disclosure, the imaging system 200 is configured to image a patient or a subject under examination 204 (e.g., the subject under examination 112 of FIG. 1). In one embodiment, the imaging system 200 includes the detector array 108 (see FIG. 1). The detector array 108 further includes a plurality of detector elements 202, which together sense the X-ray radiation beam 106 (see FIG. 2) passing through the subject under examination 204 (such as a patient) to acquire corresponding projection data. Therefore, in one embodiment, the detector array 108 is fabricated in a multi-slice configuration including a plurality of rows of units or detector elements 202. In such a configuration (e.g., multi-row detector CT or MDCT), one or a plurality of additional rows of detector elements 202 are arranged in a parallel configuration for acquiring projection data. The configuration may include 4, 8, 16, 32, 64, 128, or 256 detector rows. For example, a 64-slice MDCT scanner may have 64 detector rows with a collimator width of 4 cm, while a 256-slice MDCT scanner may have 256 detector rows with a collimator width of 16 cm. Therefore, four rotations of a helical scan performed by the 64-slice MDCT scanner may achieve equivalent detector coverage as a single rotation of a scan performed by the 256-slice MDCT scanner.

In certain implementations, the imaging system 200 is configured to traverse different angular positions around the subject under examination 204 to acquire required projection data. Therefore, the machine frame 102 and components mounted thereon can be configured to rotate about a center of rotation 206 to acquire projection data at different energy levels, for example. Alternatively, in an implementation in which a projection angle with respect to the subject under examination 204 changes over time, the mounted components may be configured to move along a generally curved line rather than a segment of a circumference.

Therefore, when the X-ray source 104 and the detector array 108 rotate, the detector array 108 collects the data of the attenuated X-ray beam. The data collected by the detector array 108 is then subjected to pre-processing and calibration to adjust the data so as to represent a line integral of an attenuation coefficient of the scanned subject under examination 204. The processed data is generally referred to as a projection.

In some examples, an individual detector or detector element 202 in the detector array 108 may include a photon counting detector that registers interactions of individual photons into one or more energy bins. It should be understood that the methods described herein may also be implemented using an energy integration detector.

An acquired projection data set may be used for base material decomposition (BMD). During the BMD, the measured projection is converted to a set of material density projections. The material density projections may be reconstructed to form one pair or a set of material density maps or images (such as bone, soft tissue, and/or contrast agent maps) of each corresponding base material. The density maps or images may then be associated to form a 3D volumetric image of a base material (e.g., bone, soft tissue, and/or a contrast agent) in an imaging volume.

Once reconstructed, a base material image produced by the imaging system 200 displays internal features of the subject under examination 204 represented by the densities of two base materials. The density images can be displayed to demonstrate the foregoing features. In conventional methods of diagnosing medical disease conditions (such as disease states), and more generally diagnosing medical events, a radiologist or physician would consider a hard copy or display of a density image to discern characteristic features of interest. Such features may include a lesion, size, and shape of a particular anatomical structure or organ, and other features should be discernible in the image on the basis of the skill and knowledge of an individual practitioner.

In one implementation, the imaging system 200 includes a control mechanism 208 to control movement of the components, such as the rotation of the machine frame 102 and the operation of the X-ray source 104. In certain implementations, the control mechanism 208 further includes an X-ray controller 210, configured to provide power and timing signals to the X-ray source 104. Additionally, the control mechanism 208 includes a machine frame motor controller 212, configured to control the rotational speed and/or position of the machine frame 102 on the basis of imaging requirements.

In certain implementations, the control mechanism 208 further includes a data acquisition system (DAS) 214, which is configured to sample analog data received from the detector elements 202, and to convert the analog data into a digital signal for subsequent processing. The DAS 214 may further be configured to selectively aggregate analog data from a subset of the detector elements 202 into a so-called macro detector, as described further herein. The data sampled and digitized by the DAS 214 is transmitted to a computer or computing device 216. In an example, the computing device 216 stores data in a storage device or mass storage apparatus 218. For example, the storage device 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the machine frame motor controller 212 to control system operations, such as data acquisition and/or processing. In certain embodiments, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows one operator console 220, more than one operator console may be coupled to the imaging system 200, for example, for inputting or outputting system parameters, requesting examination, mapping data, and/or viewing images. Moreover, in certain implementations, the imaging system 200 may be coupled to, for example, a plurality of displays, printers, workstations, and/or similar devices located locally or remotely within an institution or hospital or in a completely different location via one or more configurable wired and/or wireless networks (such as the Internet and/or a virtual private network, a wireless telephone network, a wireless local area network, a wired local area network, a wireless wide area network, a wired wide area network, etc.).

In one implementation, for example, the imaging system 200 includes a picture archiving and a communication system (PACS) 224 or is coupled to the PACS. In an exemplary implementation, the PACS 224 is further coupled to a remote system (such as a radiology information system or a hospital information system) and/or coupled to an internal or external network (not shown) to allow an operator at a different position to provide commands and parameters and/or obtain access to image data.

The computing device 216 uses operator-supplied and/or system-defined commands and parameters to operate an examination table motor controller 226, which can in turn control the examination table 114. The examination table may be an electric examination table. Specifically, the examination table motor controller 226 may move the examination table 114 to properly position the subject under examination 204 in the machine frame 102, so as to acquire projection data corresponding to a target volume of the subject under examination 204.

As described previously, the DAS 214 samples and digitizes the projection data acquired by the detector elements 202. Subsequently, an image reconstructor 230 uses the sampled and digitized X-ray data to perform high-speed reconstruction. Although the image reconstructor 230 is shown as a separate entity in FIG. 2, in certain implementations, the image reconstructor 230 may form a part of the computing device 216. Alternatively, the image reconstructor 230 may not be present in the imaging system 200, and the computing device 216 may instead perform one or more functions of the image reconstructor 230. In addition, the image reconstructor 230 may be located locally or remotely and may be operably connected to the imaging system 200 by using a wired or wireless network. Specifically, in one exemplary implementation, computing resources in a “cloud” network cluster may be used for the image reconstructor 230.

In one embodiment, the image reconstructor 230 stores a reconstructed image in the storage device 218. Alternatively, the image reconstructor 230 may transmit the reconstructed image to the computing device 216 to generate usable patient information for diagnosis and evaluation. In certain implementations, the computing device 216 may transmit the reconstructed image and/or patient information to a display or display device 232, the display or display device being communicatively coupled to the computing device 216 and/or the image reconstructor 230. In some implementations, the reconstructed image may be transmitted from the computing device 216 or the image reconstructor 230 to the storage device 218 for short-term or long-term storage.

FIG. 3 is a schematic diagram of a CT system during patient detection. As shown in FIG. 3, the CT system 310 generally includes a rotatable machine frame 312 and a support table 315 disposed in a hollow imaging region 314 of the rotatable machine frame 312 for carrying a patient 330. The rotatable machine frame 312 includes an X-ray source S and a detector 318 disposed opposite to the X-ray source S. The detector 318 includes a plurality of individual detector units D arranged in an array. When the rotatable machine frame 312 is located at a certain scanning position, the X-ray source S emits a fan-shaped X-ray beam 320 in a direction of the detector 318, and the plurality of detector units D respectively sense the X-rays attenuated by the patient 330, so that a set of projection data is sensed by the detector units D to obtain a corresponding frame of projection data. With the rotation of the rotatable machine frame 312, the X-ray source S and the detector 318 rotate around a center of rotation O, the CT system 310 performs a plurality of scans, and in each scan process, all the detector units D may sense and obtain each corresponding frame of projection data. In the case in which the detector units D are normal, each corresponding frame of projection data may be directly used to reconstruct one or a plurality of images. However, when there are some performance differences among the detector units D on the detector 318, that is, in the case in which the detector 318 has detector units D(n, row) with performance differences (where n is the number of columns of the detector units D(n, row) with performance differences in the array of the detector 318, and row is the number of rows of the detector units D(n, row) with performance differences in the array of the detector 318), the projection data sensed by the detector units D(n, row) with performance differences corresponding to each frame of projection data cannot correctly reflect the soft tissue features of the patient 330, therefore, the projection data sensed by the detector units D(n, row) with performance differences corresponding to each frame of projection data cannot be used, and the projection data on the detector units D(n, row) with performance differences corresponding to each frame of projection data needs to be estimated as accurately as possible by the method of the present invention described below.

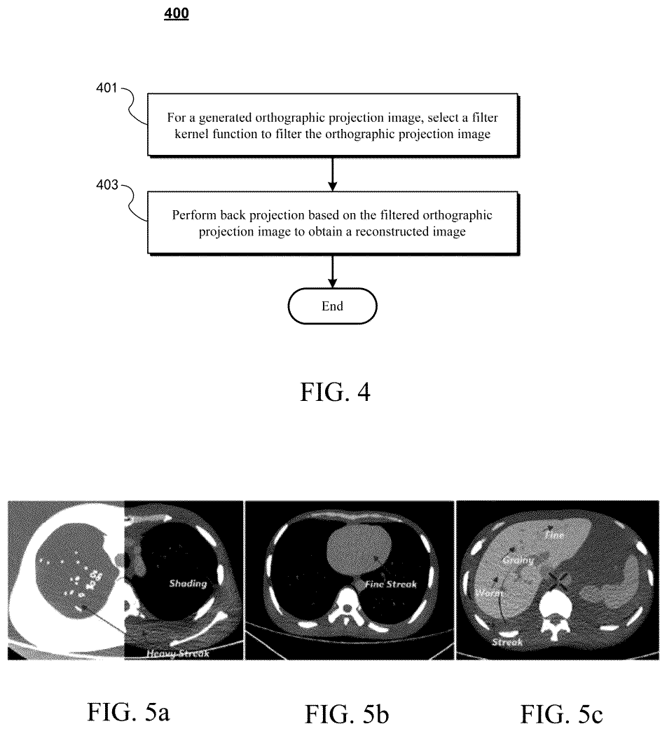

FIG. 4 is a flowchart of an image reconstruction method 400. In step 401, for a generated orthographic projection image, a filter kernel function is selected to filter the orthographic projection image. Next, in step 403, back projection is performed based on the filtered orthographic projection image to obtain a reconstructed image. In one acquired tomographic image, different soft tissues and high-frequency tissues usually exist at the same time, for example, the lung and the vertebra, the heart and the vertebra, the liver and the vertebra, and brain soft tissue and the skull. Different tissues correspond to different convolution kernels, and different filter kernel functions have different cut-off frequencies and enhancement functions. If an operator wants to clearly see information of different frequencies of different organs or tissues, the orthographic projection image needs to be filtered using different filter kernel functions to obtain orthographic projection images enhanced by different frequencies, and then the orthographic projection images enhanced by different frequencies are reconstructed. This means a plurality of reconstruction operations, more requirements on disk space, more complex image comparison view, and may face poor image performance, even more print film occupation in some image regions. Another method is to design a compromise filter kernel function, and this means that the filtering is not optimized for a specific organ or tissue, resulting in a less clear reconstructed image.

FIG. 5a to FIG. 5c show reconstructed images obtained according to an image reconstruction method. Another problem of the reconstructed images obtained by the image reconstruction method 400 is artifacts, as shown in FIG. 5a to FIG. 5c. Such artifacts are often or always present in the lung base, liver base, and heart, as these organ sites are close to the vertebrae. Through back projection, such artifacts traverse the images of the lung base, liver base, and heart, resulting in reduced resolution, non-uniform noise texture, and unsightly images.

Therefore, the present disclosure proposes a method for improving the quality of a target organ or region of interest (ROI) image and improving work efficiency. The method of the present disclosure can enable all organs or ROIs included in a same image to be reconstructed with optimized image quality (artifact reduction, resolution improvement), and can simplify the processing process, reduce the disk space requirement, and improve the work efficiency (by simplifying the work process, lowering the requirement on the disk space, and the like).

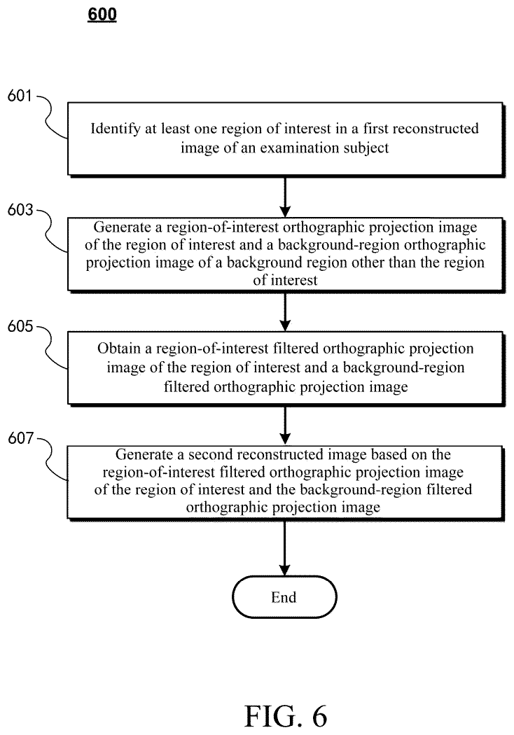

FIG. 6 is a flowchart of an image reconstruction method 600 for a medical imaging system according to one embodiment of the present disclosure.

In step 601, at least one region of interest in a first reconstructed image of an examination subject is identified. For example, the first reconstructed image may include a region of interest A. It should be understood that only the region of interest A is used herein to refer to one region of interest for ease of description, and those skilled in the art should conceive that the first reconstructed image may further include one or a plurality of other regions of interest or may not include other regions of interest. Preferably, a boundary of each region of interest A may be acquired in step 601. Preferably, the first reconstructed image may be obtained by performing reconstruction on the examination subject at a maximum field of view of the medical imaging system. Preferably, each region of interest A among the at least one region of interest may be labeled with an anatomical structure (e.g., an organ, a tissue, etc.) of the examination subject, and further preferably, may be automatically labeled with the anatomical structure of the examination subject through deep learning.

In step 603, a region-of-interest orthographic projection image Sino_{A} of each region of interest A among the at least one region of interest and a background-region orthographic projection image Sino_{background} of a background region other than the regions of interest are generated. As an example, the generating the background-region orthographic projection image Sino_{background} may include performing an orthographic projection for the first reconstructed image from which the at least one region of interest A is removed to obtain the background-region orthographic projection image Sino_{background}. In a case in which there are a plurality of regions of interest A1, A2, and A3, the background region is a region other than the regions of interest A1, A2, and A3 in the first reconstructed image.

As an example, the generating the region-of-interest orthographic projection image Sino_{A} of each region of interest A may include: for each region of interest A, performing an orthographic projection only for a current region of interest A in the first reconstructed image to generate a region-of-interest orthographic projection image Sino_{A} of the current region of interest A.

As another example, the generating the region-of-interest orthographic projection image Sino_{A} of each region of interest A may include: for each region of interest A, generating an other-region orthographic projection image Sinoₒₜₕₑᵣ of regions other than the current region of interest A in the first reconstructed image, and then subtracting the other-region orthographic projection image Sinoₒₜₕₑᵣ from an orthographic projection image Sino₁ corresponding to the first reconstructed image to generate a region-of-interest orthographic projection image Sino_{A} of the current region of interest A. It should be noted that in the case in which there are a plurality of regions of interest A1, A2and A3, for the current region of interest A1, the other regions include the region of interest A2, the region of interest A3, and the background region; for the current region of interest A2, the other regions include the region of interest A1, the region of interest A3, and the background region; and for the current region of interest A3, the other regions include the region of interest A1, the region of interest A2, and the background region. Compared with directly generating the region-of-interest orthographic projection image Sino_{A} of the current region of interest A, this embodiment can retain more image information at the region of interest A.

In step 605, a region-of-interest filtered orthographic projection image of each region of interest and a background-region filtered orthographic projection image are obtained. For each region of interest A among the at least one region of interest, the region-of-interest filtered orthographic projection image Sino_{A}_F is obtained by filtering a current-region-of-interest orthographic projection image Sino_{A} using a filter kernel function relatively matched with the current region of interest A. In addition, for the background region, the background-region filtered orthographic projection image Sino_{background}_F is obtained by filtering a background-region orthographic projection image Sino_{background} using a filter kernel function relatively matched with the background region. Preferably, the filter kernel function relatively matched with the region of interest A and the filter kernel function relatively matched with the background region may be determined based on an optimal filtering frequency of a corresponding region (the region of interest and the background region). This is because frequencies of convolution kernels, that is, the cut-off frequencies, required for different tissues in different regions are different. Using a higher frequency indicates a sharper image and a more server artifact. If the frequency is low, the image is less clear. Therefore, it is necessary and allowed in this embodiment to select convolution kernels matched with target regions respectively to filter the target regions respectively, thereby obtaining the best imaging effect.

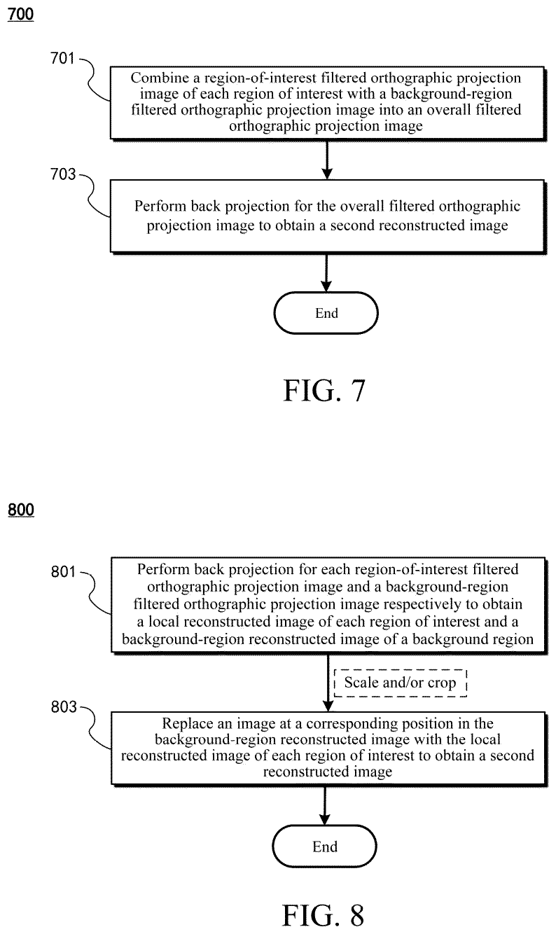

In step 607, a second reconstructed image is generated based on the region-of-interest filtered orthographic projection image Sino_{A}_F of each region of interest and the background-region filtered orthographic projection image Sino_{background}_F. This step is described in detail with reference to FIG. 7 and FIG. 8.

FIG. 7 is a flowchart of a method 700 for generating a second reconstructed image according to one embodiment of the present disclosure. In step 701, the region-of-interest filtered orthographic projection image Sino_{A}_F of each region of interest and the background-region filtered orthographic projection image Sino_{background}_F are combined into an overall filtered orthographic projection image Sinoₒᵥₑᵣₐₗₗ_F. In step 703, back projection is performed on the overall filtered orthographic projection image Sinoₒᵥₑᵣₐₗₗ_F to obtain the second reconstructed image I_R.

FIG. 8 is a flowchart of a method 800 for generating a second reconstructed image according to another embodiment of the present disclosure. In step 801, back projection is performed on each region-of-interest filtered orthographic projection image Sino_{A}_F and the background-region filtered orthographic projection image Sino_{background}_F respectively to obtain a local reconstructed image I_{A}_R of each region of interest A and a background-region reconstructed image I_{background}_R of the background region.

In step 803, the image at the corresponding position in the background-region reconstructed image I_{background}_R is replaced with the local reconstructed image I_{A}_R of each region of interest A to obtain a second reconstructed image I_R. Preferably, the local reconstructed image I_{A}_R of each region of interest A may be scaled to obtain a same range as the image at the corresponding position in the background-region reconstructed image I_{background}_R, and the image at the corresponding position in the background-region reconstructed image I_{background}_R is replaced with the scaled local reconstructed image. The corresponding position of each region of interest A may be determined based on a boundary of each region of interest A (for example, acquired in the aforementioned step 601). In this way, a position of the local reconstructed image I_{A}_R in the background-region reconstructed image I_{background}_R may be determined by using boundary information of the region of interest A obtained in step 601, without re-determining the position. This is advantageous because if the position is re-determined, a part of information may be lost after the local reconstructed image I_{A}_R is combined with the background-region reconstructed image I_{background}_R, resulting in an incomplete image.

Further, the scaled local reconstructed image I_{A}_R of each region of interest A may be further cropped based on a range of the corresponding position in the background-region reconstructed image I_{background}_R to remove a portion of the scaled local reconstructed image I_{A}_R outside the range of the corresponding position. This is because, in a process of reconstructing the local reconstructed image I_{A}_R of each region of interest A, redundant image information, for example, noise information, may be generated outside the boundary of the corresponding region of interest A. In this embodiment, redundant information outside these boundaries can be removed, to avoid being combined into the background-region reconstructed image I_{background}_R.

By comparing the method 700 for generating the second reconstructed image with the method 800 for generating the second reconstructed image, the method 700 only needs to perform back projection once, so the processing speed is faster, and the calculation amount is less, while the method 800 can avoid crosstalk between ROIs, and the obtained second reconstructed image is clearer than the second reconstructed image obtained by the method 700.

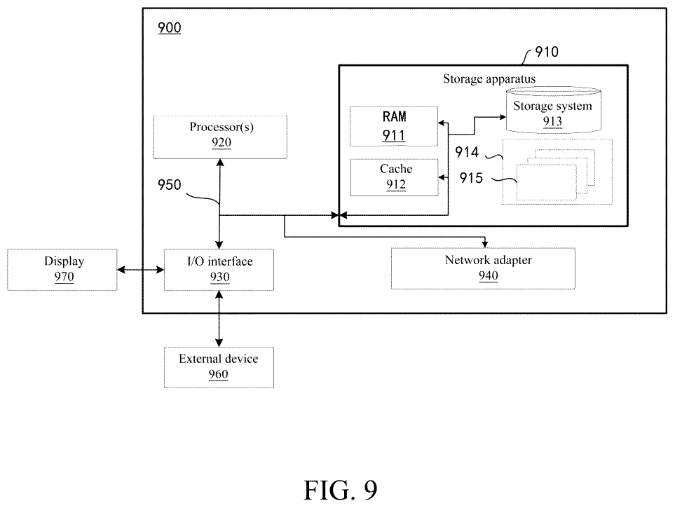

FIG. 9 is an example block diagram of a computing device 900 according to a technique of the present disclosure. The computing device 900 may be implemented as an example of the computing device 216 shown in FIG. 2. The computing device 900 includes one or a plurality of processors 920; and a storage apparatus 910, configured to store one or a plurality of programs that, when executed by the one or plurality of processors 920, cause the one or plurality of processors 920 to implement the processes described in the present disclosure. The processor is, for example, a digital signal processor (DSP), a microcontroller, an application-specific integrated circuit (ASIC), or a microprocessor.

The computing device 900 shown in FIG. 9 is merely an example, and should not impose any limitation on the function and usage scope of the embodiments of the present invention.

As shown in FIG. 9, the computing device 900 is represented in the form of a general-purpose computing device. Components of the computing device 900 may include, but are not limited to, one or a plurality of processors 920, a storage apparatus 910, and a bus 950 connecting different system components (including the storage apparatus 910 and the processor 920).

The bus 950 represents one or a plurality of types among several types of bus structures, including a memory bus or memory controller, a peripheral bus, a graphics acceleration port, a processor, or a local bus using any bus structure among the plurality of bus structures. For example, these architectures include, but are not limited to, an Industrial Standard Architecture (ISA) bus, a Micro Channel Architecture (MAC) bus, an enhanced ISA bus, a Video Electronics Standards Association (VESA) local bus, and a Peripheral Component Interconnect (PCI) bus.

The computing device 900 typically includes a plurality of types of computer system-readable media. These media may be any available medium that can be accessed by the computing device 900, including volatile and non-volatile media as well as removable and non-removable media.

The storage apparatus 910 may include a computer system-readable medium in the form of a volatile memory, for example, a random access memory (RAM) 911 and/or a cache memory 912. The computing device 900 may further include other removable/non-removable, and volatile/non-volatile computer system storage media. Only as an example, a storage system 913 may be configured to read/write a non-removable, non-volatile magnetic medium (not shown in FIG. 9, typically referred to as a “hard disk drive”). Although not shown in FIG. 9, a magnetic disk drive configured to read/write a removable non-volatile magnetic disk (for example, a “floppy disk”) and an optical disc drive configured to read/write a removable non-volatile optical disc (for example, a CD-ROM, a DVD-ROM, or other optical media) may be provided. In these cases, each drive may be connected to the bus 950 via one or a plurality of data medium interfaces. The storage apparatus 910 may include at least one program product which has a group of program modules (for example, at least one program module) configured to perform the functions of the embodiments of the present invention.

A program/utility tool 914 having a group (at least one) of program modules 915 may be stored in, for example, the storage apparatus 910. This program module 915 includes, but is not limited to, an operating system, one or a plurality of application programs, other program modules, and program data, and each of these examples or a certain combination thereof may include an implementation of a network environment. The program module 915 typically performs the function and/or method in any embodiment described in the present invention.

The computing device 900 may also communicate with one or a plurality of external devices 960 (such as a keyboard, a pointing device, and a display 970), and may also communicate with one or a plurality of devices that enable a user to interact with the computing device 900, and/or communicate with any device (such as a network card and a modem) that enables the computing device 900 to communicate with one or a plurality of other computing devices. Such communication may be carried out via an input/output (I/O) interface 930. Moreover, the computing device 900 may also communicate, via a network adapter 940, with one or a plurality of networks (for example, a local area network (LAN), a wide area network (WAN), and/or a public network, for example, the Internet). As shown in FIG. 9, the network adapter 940 communicates, via the bus 950, with other modules of the computing device 900. It should be understood that although not shown in the figure, other hardware and/or software modules can be used in combination with the computing device 900, including, but not limited to, microcode, device drivers, redundant processing units, external disk drive arrays, RAID systems, tape drives, data backup storage systems, and the like.

The processor 920 executes, by running programs stored in the storage apparatus 910, various functional applications and data processing, for example, implementing the processes described in the present disclosure.

The technique described herein may be implemented with hardware, software, firmware, or any combination thereof, unless specifically described as being implemented in a specific manner. Any features described as modules or components may also be implemented together in an integrated logical device, or separately implemented as discrete but interoperable logical devices. If implemented with software, the technique may be implemented at least in part by a non-transitory processor-readable storage medium that includes instructions, wherein when executed, the instructions perform one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or a plurality of aspects of at least some embodiments may be implemented by representative instructions that are stored in a machine-readable medium and represent various logic in a processor, wherein when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An example communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In an example, the network interface device may include one or a plurality of physical jacks (for example, Ethernet, coaxial, or phone jacks) or one or a plurality of antennas for connection to the communication network. In an example, the network interface device may include a plurality of antennas that wirelessly communicate using at least one technique of single-input multiple-output (SIMO), multiple-input multiple-output (MIMO), or multiple-input single-output (MISO) techniques.

The term “transmission medium” should be considered to include any intangible medium capable of storing, encoding, or carrying instructions for execution by a machine, and the “transmission medium” includes digital or analog communication signals or any other intangible medium for facilitating communication of such software.

So far, the imaging method and the imaging device according to the present invention have been described, and the computer-readable storage medium capable of implementing the method have also been described.

Some exemplary embodiments have been described above. However, it should be understood that various modifications can be made to the exemplary embodiments described above without departing from the spirit and scope of the present invention. For example, an appropriate result can be achieved if the described techniques are performed in a different order and/or if the components of the described system, architecture, device, or circuit are combined in other manners and/or replaced or supplemented with additional components or equivalents thereof; accordingly, the modified other implementations also fall within the protection scope of the claims.

1. An image reconstruction method for an imaging system, comprising:
identifying at least one region of interest in a first reconstructed image of an examination subject;
generating a region-of-interest orthographic projection image of each region of interest among the at least one region of interest and a background-region orthographic projection image of a background region other than the at least one region of interest;
obtaining a region-of-interest filtered orthographic projection image of each region of interest and a background-region filtered orthographic projection image, wherein for each region of interest among the at least one region of interest, the region-of-interest filtered orthographic projection image is obtained by filtering a current-region-of-interest orthographic projection image using a filter kernel function relatively matched with a current region of interest, and the background-region filtered orthographic projection image is obtained by filtering the background-region orthographic projection image using a filter kernel function relatively matched with the background region; and
generating a second reconstructed image based on the region-of-interest filtered orthographic projection image of each region of interest and the background-region filtered orthographic projection image.

2. The method according to claim 1, wherein
the generating the background-region orthographic projection image comprises performing an orthographic projection for the first reconstructed image from which the at least one region of interest is removed to obtain the background-region orthographic projection image; and
the generating the region-of-interest orthographic projection image of each region of interest comprises: for each region of interest,
generating an other-region orthographic projection image of regions other than the current region of interest in the first reconstructed image; and
subtracting the other-region orthographic projection image from an orthographic projection image corresponding to the first reconstructed image to generate a region-of-interest orthographic projection image of the current region of interest.

3. The method according to claim 1, wherein
the generating the background-region orthographic projection image comprises performing an orthographic projection for the first reconstructed image from which the at least one region of interest is removed to obtain the background-region orthographic projection image; and
the generating the region-of-interest orthographic projection image of each region of interest comprises: for each region of interest, performing an orthographic projection only for the current region of interest in the first reconstructed image to generate a region-of-interest orthographic projection image of the current region of interest.

4. The method according to claim 1, wherein the generating the second reconstructed image based on the region-of-interest filtered orthographic projection image of each region of interest and the background-region filtered orthographic projection image comprises:
combining the region-of-interest filtered orthographic projection image of each region of interest and the background-region filtered orthographic projection image into an overall filtered orthographic projection image; and
performing back projection for the overall filtered orthographic projection image to obtain the second reconstructed image.

5. The method according to claim 1, wherein the generating the second reconstructed image based on the region-of-interest filtered orthographic projection image of each region of interest and the background-region filtered orthographic projection image comprises:
performing back projection for each region-of-interest filtered orthographic projection image and the background-region filtered orthographic projection image respectively to obtain a local reconstructed image of each region of interest and a background-region reconstructed image of the background region; and
replacing an image at a corresponding position in the background-region reconstructed image with the local reconstructed image of each region of interest to obtain the second reconstructed image.

6. The method according to claim 5, wherein the generating the second reconstructed image further comprises:
scaling the local reconstructed image of each region of interest to obtain a same range as the image at the corresponding position in the background-region reconstructed image, and replacing the image at the corresponding position in the background-region reconstructed image with the scaled local reconstructed image.

7. The method according to claim 6, wherein the generating the second reconstructed image further comprises:
further cropping the scaled local reconstructed image of each region of interest based on a range of the corresponding position in the background-region reconstructed image to remove a portion of the scaled local reconstructed image outside the range of the corresponding position.

8. The method according to claim 1, wherein
the filter kernel functions relatively matched with the region of interest and the background region respectively are determined based on an optimal filtering frequency of a corresponding region.

9. The method according to claim 1, wherein
the first reconstructed image is obtained by performing reconstruction on the examination subject at a maximum field of view of the medical imaging system.

10. The method according to claim 1, wherein
each region of interest among the at least one region of interest is labeled with an anatomical structure of the examination subject and is automatically labeled through deep learning.

11. An imaging system, comprising:
a scanning device, configured to acquire a first reconstructed image of an examination subject; and
a processor, configured to:
identify at least one region of interest in the first reconstructed image of the examination subject;
generate a region-of-interest orthographic projection image of each region of interest among the at least one region of interest and a background-region orthographic projection image of a background region other than the at least one region of interest;
obtain a region-of-interest filtered orthographic projection image of each region of interest and a background-region filtered orthographic projection image, wherein for each region of interest among the at least one region of interest, the region-of-interest filtered orthographic projection image is obtained by filtering a current-region-of-interest orthographic projection image using a filter kernel function relatively matched with a current region of interest, and the background-region filtered orthographic projection image is obtained by filtering the background-region orthographic projection image using a filter kernel function relatively matched with the background region; and
generate a second reconstructed image based on the region-of-interest filtered orthographic projection image of each region of interest and the background-region filtered orthographic projection image.

12. The imaging system according to claim 11, wherein the processor is configured to:
generate the background-region orthographic projection image by performing an orthographic projection for the first reconstructed image from which the at least one region of interest is removed; and
generate the region-of-interest orthographic projection image of each region of interest by the following: for each region of interest, generating an other-region orthographic projection image of regions other than the current region of interest in the first reconstructed image; and
subtracting the other-region orthographic projection image from an orthographic projection image corresponding to the first reconstructed image to generate a region-of-interest orthographic projection image of the current region of interest.

13. The imaging system according to claim 11, wherein the processor is configured to:
generate the background-region orthographic projection image by performing an orthographic projection for the first reconstructed image from which the at least one region of interest is removed; and
generate the region-of-interest orthographic projection image of each region of interest by the following: for each region of interest, performing an orthographic projection only for the current region of interest in the first reconstructed image to generate a region-of-interest orthographic projection image of the current region of interest.

14. The imaging system according to claim 11, wherein the processor is configured to generate the second reconstructed image based on the region-of-interest filtered orthographic projection image of each region of interest and the background-region filtered orthographic projection image by the following:
combining the region-of-interest filtered orthographic projection image of each region of interest and the background-region filtered orthographic projection image into an overall filtered orthographic projection image; and
performing back projection for the overall filtered orthographic projection image to obtain the second reconstructed image.

15. The imaging system according to claim 11, wherein the processor is configured to generate the second reconstructed image based on the region-of-interest filtered orthographic projection image of each region of interest and the background-region filtered orthographic projection image by the following:
performing back projection for each region-of-interest filtered orthographic projection image and the background-region filtered orthographic projection image respectively to obtain a local reconstructed image of each region of interest and a background-region reconstructed image of the background region; and
replacing an image at a corresponding position in the background-region reconstructed image with the local reconstructed image of each region of interest to obtain the second reconstructed image.

16. The imaging system according to claim 15, wherein the processor is further configured to generate the second reconstructed image by the following:
scaling the local reconstructed image of each region of interest to obtain a same range as the image at the corresponding position in the background-region reconstructed image, and replacing the image at the corresponding position in the background-region reconstructed image with the scaled local reconstructed image.

17. The imaging system according to claim 16, wherein the processor is further configured to generate the second reconstructed image by the following:
further cropping the scaled local reconstructed image of each region of interest based on a range of the corresponding position in the background-region reconstructed image to remove a portion of the scaled local reconstructed image outside the range of the corresponding position.

18. The imaging system according to claim 11, wherein
the filter kernel functions relatively matched with the region of interest and the background region respectively are determined based on an optimal filtering frequency of a corresponding region.

19. The imaging system according to claim 11, wherein
the first reconstructed image is obtained by performing reconstruction on the subject at a maximum field of view of the medical imaging system.

20. The imaging system according to claim 11, wherein
each region of interest among the at least one region of interest is labeled with an anatomical structure of the subject and is automatically labeled through deep learning.
